(19) United States
(12) Patent Application Publication
(10) Pub. No.: US 2020/0048037 A1
(43) Pub. Date: Feb. 13, 2020

(54) DEVICE AND METHOD FOR MONITORING THE MOVEMENT OF AN ELEVATOR DOOR USING RFID

(71) Applicant: Otis Elevator Company, Farmington, CT (US)

(72) Inventor: Mustapha Toutaoui, Berlin (DE)

(21) Appl. No.: 16/536,985

(22) Filed: Aug. 9, 2019

(30) Foreign Application Priority Data
Aug. 10, 2018 (EP) 18188520.3

(51) Int. Cl. B66B 5/00; B66B 1/28; B66B 1/34; B66B 5/02; B66B 13/14; B66B 13/30

(52) U.S. Cl. CPC B66B 5/0025; B66B 1/28; B66B 1/3446; B66B 5/0031; B66B 13/143; B66B 13/30; B66B 5/02

(57) ABSTRACT

An elevator door monitoring system for monitoring movement of an elevator door (6, 16) includes an elevator door detector (30) including an RFID tag (32) configured for being attached to a first element (16a, 26a) of the elevator door (6, 16); and an RFID sensor (34) configured for being attached to a second element (16b, 26b) of the elevator door (6, 16), wherein the second element (16b, 26b) is movable with respect to the first element (16a, 26a). The elevator door detector (30) is configured for detecting a distance between the first and second elements (16a, 26a, 16b, 26b) of the elevator door (6, 16) and for supplying a corresponding detection signal. The elevator door monitoring system includes an evaluator (17) configured for receiving detection signals supplied by the elevator door detector (30) and for evaluating the received detection signals for detecting potential malfunctions of the elevator door.

### FOREIGN PRIORITY

This application claims priority to European Patent Application No. 18188520.3 filed Aug. 10, 2018, and all the benefits accruing therefrom under 35 U.S.C. § 119, the contents of which in its entirety are herein incorporated by reference.

### BACKGROUND

The present invention relates to a method and to a device for monitoring the movement of at least one door, in particular an elevator door. The invention further relates to an elevator system comprising elevator doors and a device for monitoring the movement of said doors.

Elevator systems respectively comprise at least one hoistway and at least one elevator car moving along the length of said hoistway. Elevator doors are provided at the hoistway and at the car in order to allow passengers to transfer between landings formed at different floors next to the hoistway and the elevator car when the elevator car is positioned next to a landing. For safe operation of the elevator system, it is to be guaranteed that the elevator doors are completely closed before the elevator car starts moving.

As the elevator doors and the mechanisms provided for moving and locking the elevator doors comprise mechanical moving elements subject to wear, contamination, fatigue and/or damage by careless passengers, they are critical components which are prone to cause a malfunction, shut down and/or blocking of the elevator system.

Thus, it would be beneficial to be able to continuously monitor the movement of the elevator doors not only to detect a failure/blocking of the doors, but to also to detect marginal disturbances of the door movement occurring in advance of a blocking or malfunction. Detecting such disturbances would allow repairing the elevator door even before a malfunction or blocking occurs and the elevator system needs to be shut down due to said malfunction or blocking.

### SUMMARY

According to an exemplary embodiment of the invention, an elevator door monitoring system, which is configured for monitoring movement of an elevator door, comprises an RFID detector including an RFID tag and an RFID sensor. The RFID tag is configured for being attached to a first element of the elevator door. The RFID sensor is configured for being attached to a second element of the elevator door, wherein the second element is movable with respect to the first element. The RFID detector is configured for detecting a distance between the first and second elements of the elevator door and for supplying a corresponding detection signal. The elevator door monitoring system further comprises an evaluator configured for receiving detection signals supplied by the RFID detector and for evaluating the received detection signals for detecting potential malfunctions of the elevator door.

Exemplary embodiments of the invention include an elevator system comprising an elevator car configured for traveling along a hoistway between a plurality of landings and at least one elevator door monitoring system according to an exemplary embodiment of the invention.

Exemplary embodiments of the invention further include a method of monitoring an elevator door of an elevator system using an elevator door monitoring system according to an exemplary embodiment of the invention.

Exemplary embodiments of the invention allow continuously monitoring the movement of the elevator doors in order to detect a failure/blocking of any of the doors. They further allow detecting marginal disturbances of the door movement occurring in advance of a blocking or malfunction. Detecting marginal disturbances of the door movement allows repairing the elevator door even before a blocking or malfunction occurs and the elevator system needs to be shut down.

A number of optional features are set out in the following. These features may be realized in particular embodiments, alone or in combination with any of the other features, unless specified otherwise.

A method of monitoring an elevator door according to an exemplary embodiment of the invention may include unambiguously identifying and/or locating the monitored elevator door based on information comprised in the detection signal.

The RFID detector may be configured for providing additional information within the supplied signal. The additional information may comprise information about the elevator door, in particular information that allows unambiguously identifying and/or locating the respective elevator door. Said information may include an unambiguous part and/or item number of the respective door. In case of an elevator landing door, the additional information may comprise information about the landing at which the elevator landing door is located. In case the respective door is an elevator car door of an elevator car with more than one elevator car door, the additional information may comprise information about the position/location of the respective door within the elevator car, e.g. whether the respective door is located at front side or at a rear side of the elevator car. The additional information may also comprise information about the vendor and/or operator of the elevator system.

The additional information provided by the RFID detector may facilitate maintenance and/or repair of the respective elevator door. It in particular may help to identify and/or localize the respective elevator door within the elevator system.

The evaluator may be configured for generating a movement pattern from the received detection signals and for comparing the generated movement pattern with at least one predefined reference pattern. The evaluator in particular may be configured for issuing an alarm and/or maintenance signal when a determined difference between the at least one generated movement pattern and the predefined reference pattern exceeds a predetermined limit.

Comparing a currently generated movement pattern with a predefined reference pattern, in particular determining a difference between the generated movement pattern and the predefined reference pattern allows detecting potential malfunctions and/or disturbances of the elevator door at an early stage, in particular before the respective malfunction and/or disturbance results in blocking the elevator door and/or the elevator system. Thus, the risk of an undesirable unscheduled downtime of the elevator system for repair due to a malfunction and/or disturbance of one of the elevator doors may be considerably reduced.

The evaluator may be configured for generating a movement pattern from the received detection signals and for storing the generated movement patterns. The evaluator in particular may be configured for comparing a current movement pattern with at least one previously stored movement pattern, and for issuing an alarm and/or maintenance signal when a difference between the current movement pattern and the at least one of the previously stored movement pattern exceeds a predetermined limit. By comparing a current movement pattern with at least one previously stored movement pattern the evaluator may detect changes of the movement pattern caused by wear, contamination and/or fatigue of components of the elevator system, in particular components of the elevator door and/or of a drive employed for driving the elevator door.

An elevator door monitored by an elevator door monitoring system according to an embodiment of the invention may comprise two door panels which are movable with respect to each other. In this case, the RFID tag may be attached to a first door panel, and the RFID sensor may be attached to a second door panel.

An elevator door monitored by an elevator door monitoring system according to an embodiment of the invention may comprise a door frame and at least one door panel which is movable with respect to the door frame. In such a configuration, one of the RFID tag and the RFID sensor may be attached to the door frame and the other one of the RFID tag and the RFID sensor may be attached to a door panel. This allows using an elevator door monitoring system according to an embodiment of the invention in combination with elevator doors comprising only one door panel.

An elevator door monitored by an elevator door monitoring system according to an embodiment of the invention may comprise a door lock including at least two shoes which are movable with respect to each other concurrently with the door panels of the elevator door. In such a configuration, the RFID tag may be attached to a first shoe of the door lock, and the RFID sensor may be attached to a second shoe of the door lock. The shoes of a door lock are well suited locations for attaching the RFID tag and/or the RFID sensor. The shoes of a door lock are usually not accessible for passengers. Thus, RFID tags and RFID sensors attached to said shoes are protected from being unauthorizedly manipulated, damaged or removed by passengers.

An elevator door monitored by an elevator door monitoring system according to an embodiment of the invention may be an elevator landing door (hoistway door) or an elevator car door. Thus, all doors of an elevator system may be monitored by an elevator door monitoring system according to an embodiment of the invention.

### DRAWING DESCRIPTION

In the following, exemplary embodiments of the invention are described in more detail with reference to the enclosed figures.

FIG. 1 shows a schematic illustration of an elevator system according to an exemplary embodiment of the invention.

FIGS. 2A and 2B schematically show a centrally opening door in its fully open state and in its completely closed state, respectively.

FIG. 3 schematically shows an elevator car within a hoistway from above.

FIGS. 4A to 4D schematically illustrate the movement of closing an elevator car door.

FIG. 5A shows an example of a signal indicating the opening of an elevator door.

FIG. 5B shows an example of a signal indicating the closing of an elevator door.

### DETAILED DESCRIPTION

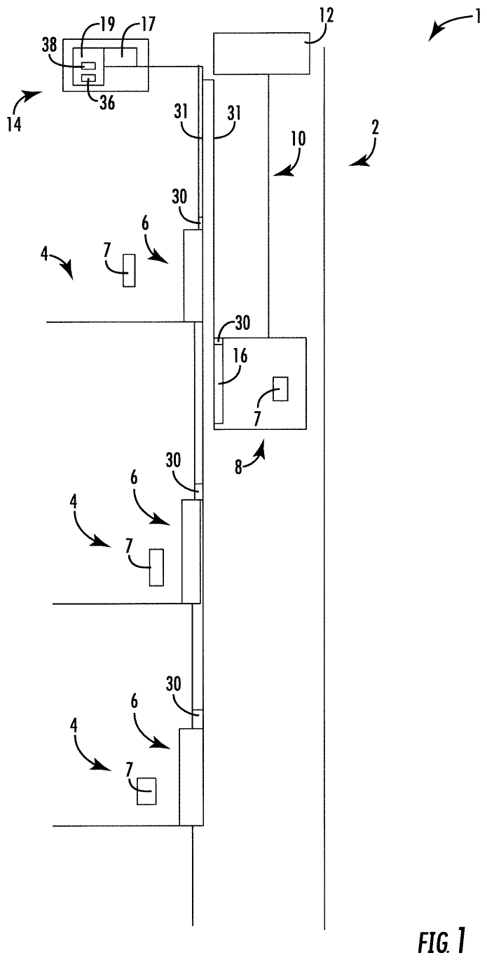

FIG. 1 shows a schematic illustration of an elevator system 1 according to an exemplary embodiment of the invention, the elevator system 1 comprising a hoistway 2 extending between a plurality of floors 4. At least one elevator landing door 6 is provided at each floor 4 allowing access to the hoistway 2 from the floor 4.

An elevator car 8 is suspended by means of a tension member 10 within the hoistway 2. The tension member 10 is connected to an elevator drive 12 provided at the top of the hoistway 2 allowing to move the elevator car 8 along the longitudinal extension of the hoistway 2 between the plurality of floors 4 by operating the elevator drive 12. The elevator drive 12 may be located in any other portion of the hoistway, e.g. in the pit, or may even be located in a separate machine room.

The tension member 10 may be a rope, e.g. a steel wire rope, or a belt. The tension member 10 may be uncoated or may have a coating, e.g. in the form of a polymer jacket. In a particular embodiment, the tension member 10 may be a belt comprising a plurality of polymer coated steel cords (not shown).

The exemplary embodiment shown in FIG. 1 uses a 1:1 roping for suspending the elevator car 8. The skilled person, however, easily understands that the type of the roping is not essential for the invention and that different kinds of roping, e.g. a 2:1 roping, or a 4:1 roping are possible as well.

The elevator system 2 may have a traction drive including a traction sheave for driving the tension member 3.

Instead of a traction drive, a hydraulic drive or a linear drive may be employed for driving the tension member 3. In an alternative configuration, which is not shown in the figures, the elevator system 2 may be an elevator system 2 without a tension member 30, comprising e.g. a hydraulic drive or a linear drive configured for driving the elevator car 6 without using a tension member 3. The elevator system 1 may have a machine room (not shown) or may be a machine room-less elevator system.

Optionally, the elevator system 1 may include a counterweight (not shown) attached to the tension member 10 and moving concurrently and in opposite direction with respect to the elevator car 8.

The elevator car 8 comprises at least one elevator car door 16, which is located opposite to a corresponding elevator landing door 6 when the elevator car 8 is positioned at a specific floor 4. The elevator car door 16 and the corresponding elevator landing door 6 open in coordination to each other in order to allow passengers to transfer between the elevator car 8 and the respective floor 4.

In the following, the term “elevator doors”, unless further specified, refers to elevator landing doors 6 as well as to elevator car doors 16.

The elevator drive 12 is functionally connected to an elevator controller 14 controlling the movement of the elevator car 8 and the opening and closing of the elevator doors 6, 16. The elevator controller 14 comprises an evaluator 17 and a memory 19 for storing movement patterns 36, 38 of the elevator doors 6, 16. The evaluator 17 and the memory 19 will be discussed in more detail further below.

A plurality of elevator control means (control panels) 7 are provided at each of the floors 4 and/or within the elevator car 8 allowing passengers to input control commands causing the elevator drive 12 to move the elevator car 8 to a desired floor 4.

Signals generated by the elevator control means 7 may be transmitted to the elevator controller 14 by means of electric wires, which are not shown in FIG. 1. The signals in particular may be transmitted via an electric (field) bus, such as a CAN bus (not shown). Alternatively or additionally, the signals may be transmitted by means of wireless data connections.

In order to ensure a safe operation of the elevator system 1, it is desirable to monitor the movement of the elevator doors 6, 16, in particular to ensure that all elevator doors 6, 16 are properly closed before the elevator car 8 starts moving, in order to prevent passengers from falling into the hoistway and/or getting trapped between the floor 4 and the moving elevator car 8.

Thus, an elevator door detector 30, which is configured for detecting the position and/or movement of a respectively associated elevator door 6, 16, is arranged next to each of the elevator doors 6, 16, respectively.

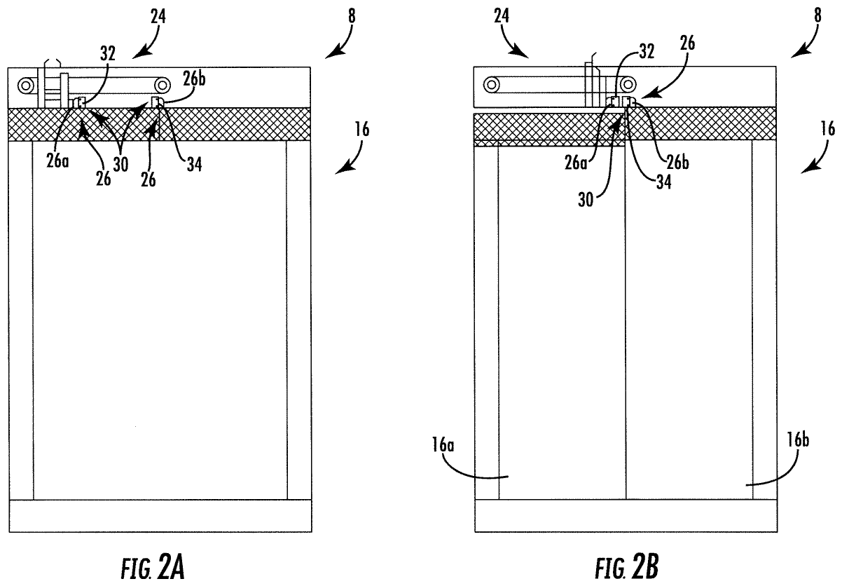

FIGS. 2A and 2B show front views of an elevator car 8 according to an exemplary embodiment of the invention, respectively.

FIGS. 2A and 2B schematically depict an elevator car 8 with a centrally opening elevator car door 16 comprising a door frame 15 and two door panels 16a, 16b. In FIG. 2A the elevator car door 16 is depicted in a fully open state, and in FIG. 2B the elevator car door 16 is depicted a completely closed state.

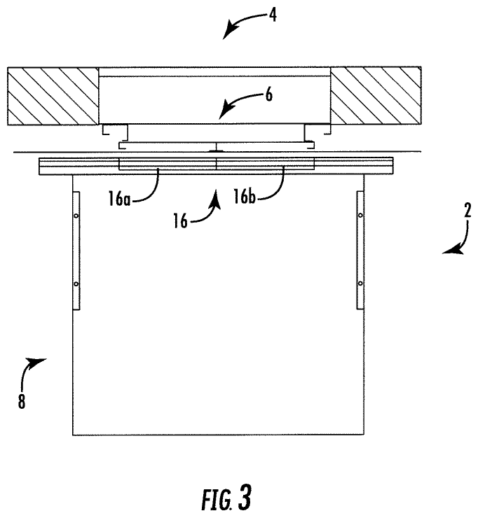

FIG. 3 schematically shows the elevator car 8 with the elevator car door 16 and an elevator landing door 6 from above.

In the following, the functionality of the elevator door detectors 30 according to exemplary embodiments of the invention is described in more detail with respect to a centrally opening elevator car door 16 comprising two door panels 16a, 16b moving in opposite direction to each other. The skilled person, however, will easily understand that the invention may be similarly applied to elevator landing doors 6. The elevator car doors 16 and hoistway doors 6 monitored by an elevator door detector 30 according to an exemplary embodiment of the invention may include telescopic elevator doors (not shown) comprising two or more door panels 16a, 16b moving parallel to each other and/or elevator doors (not shown) comprising less ore more than two door panels 16a, 16b moving in opposite direction to each other.

In FIGS. 2A and 2B, a door drive mechanism 24 is schematically illustrated on top of the elevator car door 16. Also depicted is an elevator car door lock 26 comprising a pair of shoes 26a, 26b.

The shoes 26a, 26b of the door lock 26 are spaced apart from each other, when the corresponding door 16 is open (see FIG. 2A), and the shoes 26a, 26b are positioned close to each other or even in contact with each other, when the corresponding door 16 is completely closed (see FIG. 2B).

Thus, the movement of each of the elevator car doors 16 can be reliably monitored by inspecting the movement of the shoes 26a, 26b of the corresponding door lock 26.

According to exemplary embodiments of the invention, an elevator door detector 30 is provided at each door lock 26. Each elevator door detector 30 is configured for monitoring the movement of the shoes 26a, 26b of the associated door lock 26. Each elevator door detector 30 in particular is configured for detecting the distance between the shoes 26a, 26b of the associated door lock 26 and providing a corresponding detection signal.

The elevator door monitoring system further comprises an evaluator 17 (see FIG. 1). The evaluator 17 may be integrated with the elevator controller 14 or may be provided separate from the elevator controller 14.

The detection signals provided by the elevator door detectors 30 may be transmitted to the evaluator 17 via electrical wires 31, in particular an electric (field) bus, such as a CAN bus. Alternatively or additionally, the detection signals may be transmitted via a wireless data connection.

The evaluator 17 is configured for receiving the detection signals supplied by the elevator door detectors 30 and for evaluating the received detection signals in order to detect any disturbances of the movement of the corresponding elevator door 6, 16.

Each elevator door detector 30 comprises an RFID tag 32 attached to a first shoe 26a of the respective door lock 26; and an RFID sensor 34 attached to a second shoe 26b of the respective door lock 26.

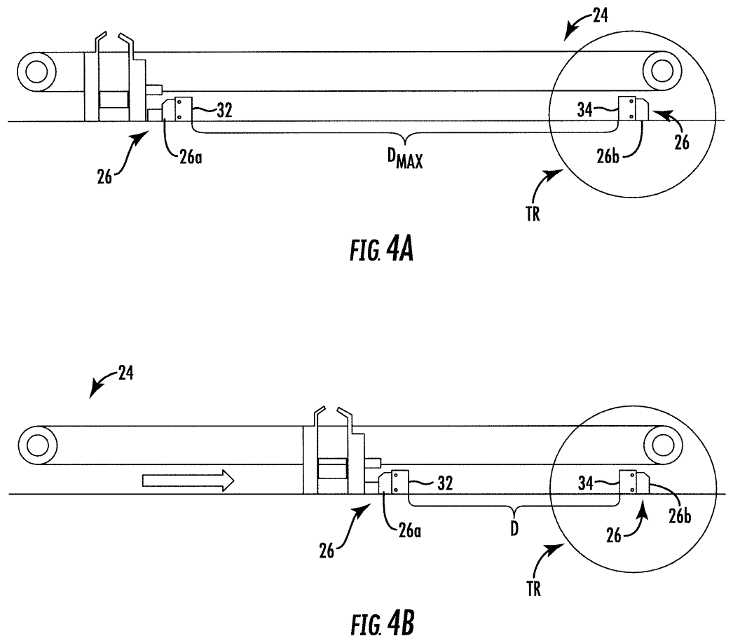

The RFID sensor 34 is configured for activating the RFID tag 32 by energy transferred from the RFID sensor 34 to the RFID tag 32 by means of electromagnetic radiation generated and emitted by the RFID sensor 34. The RFID tag 32 in particular is activated when the RFID tag 32 is located within the transmission range TR (active zone) of the RFID sensor, i.e. when a distance D between the RFID sensor 34 to the RFID tag 32 is smaller than a predefined distance D_{L} (see FIGS. 4A to 4D).

FIGS. 4A to 4D schematically illustrate the movement of an elevator car door 16 in more detail.

In FIG. 4A the elevator car door 16 is completely open and the shoes 26a, 26b of the door lock 26 are spaced apart from each other at a maximum distance D_{MAX}. In consequence, the RFID tag 32 attached to the first shoe 26a is located outside the transmission range TR (active zone) of the RFID sensor 34 attached to the second shoe 26b. As a result, the RFID tag 32 is not active and does not send any signals when the elevator car door 16 is completely open.

When the elevator car door 16 is gradually closed, i.e. when the door panels 16a, 16a approach each other (cf. FIGS. 4B and 4C), the first shoe 26a of the door lock 26 moves to the right side reducing the distance D between the first shoe 26a and the second shoe 26b of the door lock 26.

In FIG. 4C, the distance D between the first shoe 26a and the second shoe 26b of the door lock 26 is reduced to the predefined distance D_{L} so that the RFID tag 32 attached to the first shoe 26a enters into the transmission range TR (active zone) of the RFID sensor 34 attached to the second shoe 26b. In consequence, the RFID tag 32 is activated by electromagnetic radiation generated and emitted by the RFID sensor 34. When activated, the RFID tag 32 responds by emitting an electromagnetic signal comprising information indicating the distance between the first and second shoes 26a, 26b, i.e. a signal representative of the opening state of the elevator car door 16.

The signal transmitted by the RFID tag 32 may comprise additional information stored within the respective RFID tag 32. Said information may include information about the respective elevator door 6, 16, in particular information which allows unambiguously identifying the respective elevator door 6, 16, such as an unambiguous part/item number of the respective elevator door 6, 16. In case of an elevator landing door 6 said information may comprise information about the respective landing 4. In case the respective elevator door 6, 16 is an elevator car door 16 of an elevator car 8 comprising more than one elevator car door 16, the transmitted signal may comprise information about the position of the respective elevator car door 16 within the elevator car 8, e.g. whether the respective elevator car door 16 is located at a front side or at a rear side of the elevator car 8. The signal may further comprise information about the vendor and/or operator of the elevator system 1.

FIG. 4D illustrates a final state in which the elevator car door 16 is completely closed and the shoes 26a, 26b of the car door lock 26 are positioned next to each other. The RFID tag 32 and the RFID sensor 34 attached to the shoes 26a, 26b of the car door lock 26 may even contact each other when the elevator car door 16 is arranged in its final state.

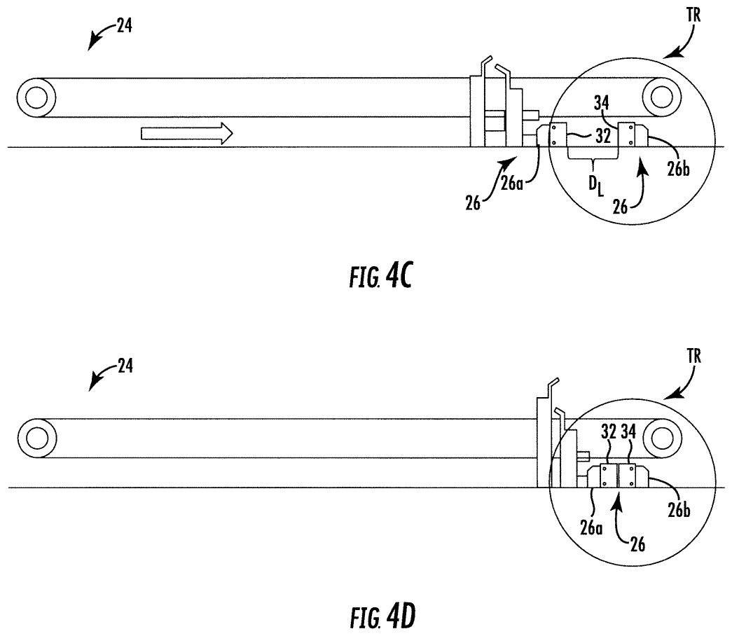

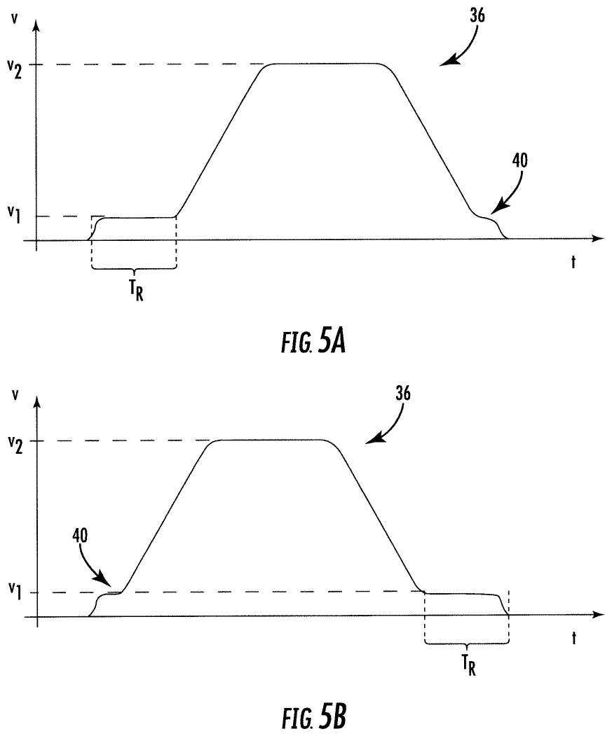

Examples of signals indicating the movement of an elevator door 6, 16, as they are generated and emitted by the RFID sensor 34, are depicted in FIGS. 5A and 5B. The curves shown in FIGS. 5A and 5B in particular are first derivatives of the distance D between the shoes 26a, 26b of the door lock 26 with respect to time. Thus, the curves depicted in FIGS. 5A and 5B indicate the speed v of the movement of the shoes 26a, 26b (y-axis) as a function of time t (x-axis).

The signal plotted in FIG. 5A represents an opening movement of the elevator car door 16, and the signal plotted in FIG. 5B represents a closing movement of the elevator car door 16.

In FIGS. 5A and 5B, T_{R} refers to the time interval in which the RFID tag 23 is arranged within the transmission range TR (active zone) of the RFID sensor 34.

FIGS. 5A and 5B both show that the door panels 16a, 16b move with a reduced (slow) speed v₁, when the RFID tag 23 is arranged within the transmission range TR (active zone) of the RFID sensor 34, i.e. when the door panels 16a, 16b are arranged relatively close to each other at the beginning or at the end of the motion, respectively.

The door panels 16a, 16b move with a higher speed v₂, when the RFID tag 23 is arranged outside the transmission range TR (active zone) of the RFID sensor 34, i.e. when the shoes 26a, 26b of the door lock 26 are spaced apart from each other more than the predefined distance D.

At the end or at the beginning of the respective movement, when the door panels 16a, 16a are maximally spaced apart from each other, there is a “creeping phase” 40, i.e. a further movement with reduced speed, in order to avoid mechanical disturbances at the beginning and the end of the door movement. The creeping phase 40 is not relevant for the present invention.

In FIGS. 5A and 5B the speed v of the door panels 16a, 16b during the creeping phase 40 is basically identical with the reduced speed v₁. This, however, is not mandatory. The speed v during the creeping phase 40 may differ from the reduced speed v₁, and the speed profile during the creeping phase 40 may differ from the creeping phase speed profiles depicted in FIGS. 5A and 5B.

The signals depicted in FIGS. 5A and 5B constitute movement patterns 36 of the movement of the respective elevator door 6, 16.

These movement patterns 36 may be compared with predefined reference patterns 38. Such reference patterns 38, for example, may be stored in a memory 19 connected or integrated with the evaluator 17 (see FIG. 1).

For example, a difference between an actually measured movement pattern 36 and a predefined reference pattern 38 representing an optimal (non-disturbed) movement of the respective elevator door 6, 16 may be determined, in particular calculated. The evaluator 17 may issue an alarm and/or maintenance signal indicating an unusual situation issued in case the determined difference exceeds a predefined limit. Said alarm and/or maintenance signal may request a mechanic to visit the elevator system 2 in order to examine the determined deviation from the predefined reference pattern 38 and to solve the detected problem(s).

The predefined reference pattern 38 also may correspond to a certain malfunction of the elevator door 6, 16, e.g. a blocking of the elevator door 6, 16. In such a configuration, an alarm and/or maintenance signal may be issued in case the determined difference between the measured movement pattern 36 and the predefined reference pattern 38 is smaller than a predefined limit indicating that it is very likely that the malfunction associated with the predefined reference pattern 38 has occurred.

Additionally or alternatively, any further operation of the elevator system 2 may be stopped until the detected deviation has been analyzed and/or the underlying problem has been solved.

Additionally or alternatively, at least some of the movement patterns 36 generated from the signals provided by the elevator door sensor(s) 30 may be stored within the memory 19. For example, a movement pattern 36 of any opening and/or closing motion of the elevator doors 6, 16 may be stored. Alternatively, in order to reduce the memory required for storing the movement patters, only every n-th movement pattern 36 may be stored (n being an integer larger than 1), and/or a new movement pattern 36 may be stored only after a predefined time interval.

A new movement pattern 36, for example, may be stored every minute, every hour, every day, or after any other predefined time interval. Additionally or alternatively, the oldest movement pattern(s) 36 may be deleted in order to provide free space in memory for storing the newest movement pattern(s) 36.

The evaluator 17 may be configured for comparing the most recent movement pattern(s) 36 with at least one previously stored movement pattern 36, and for issuing an alarm and/or maintenance signal in case a difference between the most recent movement pattern 36 and at least one of the previously stored movement patterns 36, or a function, in particular an average, of previously stored movement patterns 36, exceeds a predefined limit.

Comparing the most recent movement pattern(s) 36 with at least one predefined reference pattern 38 and/or a previously stored movement pattern 36 allows the evaluator 17 to detect changes of the movement pattern 36 of the elevator door 6, 16, which may occur due to wear, contamination and/or fatigue of components of the elevator door 6, 16, in particular of the door drive mechanism 24.

Comparing the most recent movement pattern(s) 36 with at least one predefined reference pattern 38 and/or a previously stored movement pattern 36 further may be used for determining a predicted maintenance or repair time for the elevator system 2 and/or one of its components, in particular components related to an elevator door 6, 16.

Determining a predicted maintenance or repair time allows repairing and/or replacing components before a malfunction occurs in order to avoid an unscheduled downtime of the elevator system 2 caused by a malfunction of one of said components. Determining a predicted maintenance or repair time according to an exemplary embodiment of the invention further avoids an unnecessary early replacement of components of the elevator system 2 based on a fixed time schedule which does not take into account the actual wear, contamination and/or fatigue of the respective components. This saves the costs associated with such an unnecessary early replacement.

As a result, a reliable and cost-effective operation of the elevator system 2 may be ensured.

While the invention has been described with reference to exemplary embodiments, it will be understood by those skilled in the art that various changes may be made and equivalents may be substituted for elements thereof without departing from the scope of the invention. In addition, many modifications may be made to adopt a particular situation or material to the teachings of the invention without departing from the essential scope thereof. Therefore, it is intended that the invention shall not be limited to the particular embodiment disclosed, but that the invention includes all embodiments falling within the scope of the dependent claims.

### REFERENCES

1 elevator system
2 hoistway
4 floor
6 elevator landing door
8 elevator car
10 tension member
12 elevator drive
14 elevator controller
15 door frame
16 elevator car door
16a, 16b car door panel
17 evaluator
19 memory
24 door drive mechanism
26 car door lock
26a first shoe of the car door lock
26b second shoe of the car door lock
30 elevator door detector
31 electrical wires
32 RFID tag
34 RFID sensor
36 movement pattern
38 reference pattern
40 creeping phase
TR transmission range
T_{R} time interval corresponding to the transmission range

What is claimed is:

1. Elevator door monitoring system for monitoring movement of an elevator door (6, 16), the elevator door monitoring system comprising:
an elevator door detector (30) comprising:
an RFID tag (32) configured for being attached to a first element (16a, 26a) of the elevator door (6, 16); and
an RFID sensor (34) configured for being attached to a second element (16b, 26b) of the elevator door (6, 16), wherein the second element (16b, 26b) is movable with respect to the first element (16a, 26a);
wherein the elevator door detector (30) is configured for detecting a distance between the first and second elements (16a, 26a, 16b, 26b) of the elevator door (6, 16) and for supplying a corresponding detection signal; and
wherein the elevator door monitoring system further comprises an evaluator (17) configured for receiving detection signals supplied by the elevator door detector (30) and for evaluating the received detection signals for detecting potential malfunctions of the elevator door (6, 16).

2. Elevator door monitoring system according to claim 1, wherein the signals supplied by the elevator door detector (30) comprise information about the elevator door (6, 16), in particular information which allows unambiguously identifying and/or locating the elevator door (6, 16).

3. Elevator door monitoring system according to claim 1, wherein the evaluator (17) is configured for generating a movement pattern (36) from the received detection signals and for comparing the generated movement pattern (36) with at least one predefined reference pattern (38), wherein the evaluator (17) in particular is configured for issuing an alarm and/or maintenance signal when a difference between the generated movement pattern (36) and the at least one predefined reference pattern (38) exceeds a predetermined limit.

4. Elevator door monitoring system according to claim 1, wherein the evaluator (17) is configured for generating a movement pattern (36) from the received detection signals and for storing the generated movement pattern (36), wherein the evaluator (17) in particular is configured for comparing a current movement pattern (36) with at least one previously stored movement pattern (36), and for issuing an alarm and/or maintenance signal when a difference between the current movement pattern (36) and the at least one of the previously stored movement pattern (36) exceeds a predetermined limit.

5. Elevator door (6, 16), comprising:
at least two elements (16a, 26a, 16b, 26b) which are movable with respect to each other; and
an elevator door monitoring system according to claim 1.

6. Elevator door (6, 16) according to claim 5, wherein the elevator door (6, 16) comprises two door panels (16a, 16b) which are movable with respect to each other, and wherein the RFID tag (32) is attached to a first door panel (16a), and the RFID sensor (34) is attached to a second door panel (16b).

7. Elevator door according to claim 5, wherein the elevator door (6, 16) comprises a door frame (15) and at least one door panel (16a, 16b) which is movable with respect to the door frame (15), and wherein one of the RFID tag (32) and the RFID sensor (34) is attached to the door frame (15) and the other one of the RFID tag (32) and the RFID sensor (34) is attached to a door panel (16a, 16b).

8. Elevator door according to claim 5, wherein the elevator door (6, 16) comprises a door lock (26) comprising at least two shoes (26a, 26b) which are movable with respect to each other, wherein the RFID tag (32) is attached to a first shoe (26a) of the door lock (26), and the RFID sensor (34) is attached to a second shoe (26a) of the door lock (26b).

9. Elevator door (6, 16) according to claim 5, wherein the elevator door (6, 16) is an elevator landing door (6) or an elevator car door (16).

10. Elevator system (1), comprising:
an elevator car (8) configured for traveling along a hoistway (2) between a plurality of landings (4); and
at least one elevator door (6, 16) according to claim 5.

11. Method of monitoring an elevator door (6, 16) of an elevator system (1) using an elevator door monitoring system according to claim 1.

12. Method of monitoring an elevator door (6, 16) according to claim 11, wherein the method includes unambiguously identifying and/or locating the monitored elevator door (6, 16) based on information comprised in the detection signal.

13. Method of monitoring an elevator door (6, 16) according to claim 11, wherein the method includes
generating a movement pattern (36) from the received detection signals;
comparing the generated movement pattern (36) with a predefined reference pattern (38); and
issuing an alarm and/or maintenance signal when a difference between the generated movement pattern (36) and the predefined reference pattern (38) exceeds a predetermined limit.

14. Method of monitoring an elevator door (6, 16) according to claim 11, wherein the method includes
generating a movement pattern (36) from the received detection signals;
storing the generated movement pattern (36).

15. Method of monitoring an elevator door (6, 16) according to claim 14, wherein the method further includes:
comparing a current movement pattern (36) with at least one previously stored movement pattern (36); and
issuing an alarm and/or maintenance signal when a difference between the current movement pattern (36) and the at least one of the previously stored movement pattern (36) exceeds a predetermined limit.
